(19) United States
(12) Patent Application Publication
(10) Pub. No.: US 2017/0269655 A1
(43) Pub. Date: Sep. 21, 2017

(54) ELECTRONIC DEVICE

(71) Applicant: Huawei Technologies Co., Ltd., Shenzhen (CN)

(72) Inventors: YungHsin Chu, Taipei (CN); Chieh-Hung Hsieh, Taipei (CN); Chien-Nan Lin, Taipei (CN)

(21) Appl. No.: 15/458,747

(22) Filed: Mar. 14, 2017

(30) Foreign Application Priority Data
Mar. 15, 2016 (CN) 201610146301.4

(51) Int. Cl. G06F 1/20

(52) U.S. Cl. CPC G06F 1/206

(57) ABSTRACT

An electronic device includes a display, a user interface, and a heat generating component, where the heat generating component includes a processor; the display is configured to display a temperature control parameter during operation of the electronic device; the user interface is configured to receive the adjustment instruction that is generated when a user selects the temperature control parameter; the processor is configured to obtain a target operating parameter corresponding to the adjustment instruction, and adjust at least part of elements in the heat generating component from an operating parameter that corresponds to a preset first temperature threshold to the target operating parameter, where the target operating parameter corresponds to a target temperature.

### CROSS-REFERENCE TO RELATED APPLICATIONS

This application claims priority to Chinese Patent Application No. 201610146301.4, filed on Mar. 15, 2016, which is hereby incorporated by reference in its entirety.

### TECHNICAL FIELD

The present invention relates to the field of electronic technologies, and in particular, to an electronic device.

### BACKGROUND

With rapid development of IT (information technology), many electronic devices use a new multi-core high-frequency processor architecture, consequently heat generated by the electronic devices increases greatly. Commonly used electronic devices include a mobile phone, a smart watch, a notebook computer, a wearable device, and the like.

In an existing temperature control solution for electronic devices, such as IPA (Intelligent Power Allocation), or EAS (Energy-Aware-Scheduling), “one or more groups of” prewritten temperature control parameters are obtained according to original architecture designs of electronic devices and housing materials of the electronic devices and are used for temperature control. In this way, for convenient and uniform production, electronic devices of a same model have a uniform factory setting. However, in order that surface temperatures of the electronic devices can satisfy feelings of most users, efficiency of a processor in a chip may not be released completely. In addition, heat generated by chips may not be completely the same, and therefore, the prewritten temperature control parameters may not be suitable to all users.

Although each product already has one or more sets of basic factory-set temperature control solutions and meets experience of most users, the temperature may not be satisfactory to some users.

Consequently, user experience is affected to some extent. To improve the user experience, further assessments and measurements may be made in terms of temperature control, so as to obtain a temperature that is relatively satisfactory to most users.

### SUMMARY

Embodiments of the present invention provide an electronic device, so as to adjust an operating parameter of a heat generating component in the electronic device according to an adjustment instruction that is generated when a user selects a temperature control parameter, so that a surface temperature of the electronic device maintains a target temperature that is acceptable to the user.

A first aspect of the embodiments of the present invention provides an electronic device, where the electronic device may include: a display, a user interface, and a heat generating component, where the heat generating component includes a processor;

the display is configured to display a temperature control parameter during operation of the electronic device;

the user interface is configured to receive an adjustment instruction that is generated when a user selects the temperature control parameter; and

the processor is configured to: obtain a target operating parameter corresponding to the adjustment instruction, and adjust at least part of elements in the heat generating component from an operating parameter that corresponds to a preset first temperature threshold to the target operating parameter, where the target operating parameter corresponds to a target temperature.

In this embodiment of the present invention, a user interface receives the adjustment instruction that is generated when a user selects a temperature control parameter, and the processor obtains a target operating parameter corresponding to the adjustment instruction, and adjusts at least part of elements in a heat generating component from an operating parameter that corresponds to a preset first temperature threshold to the target operating parameter, where the target operating parameter corresponds to a target temperature. Because the temperature control parameter selected by the user is a surface temperature, acceptable to the user, of the electronic device, user experience is improved.

With reference to the first aspect of the embodiments of the present invention, in a first possible implementation manner of the first aspect of the embodiments of the present invention,

the display is further configured to display a first temperature threshold cancel identifier;

the user interface is further configured to receive a cancel instruction that is generated when the user selects the first temperature threshold cancel identifier; and

the processor is further configured to cancel, according to the cancel instruction received by the user interface, control by using the first temperature threshold, so that the operating parameter of the at least part of elements is not limited by the first temperature threshold.

In this embodiment of the present invention, if before adjusting the operating parameter of the at least part of elements, the user first cancels the control by using the first temperature threshold, so that the operating parameter of the at least part of elements is not limited by the first temperature threshold. In this case, the surface temperature of the electronic device may be greater than the first temperature threshold, and performance may be better.

With reference to the first aspect of the embodiments of the present invention, or the first possible implementation manner of the first aspect of the embodiments of the present invention, in a second possible implementation manner of the first aspect of the embodiments of the present invention,

when the target temperature is less than the first temperature threshold, the processor is specifically configured to lower the operating parameter of the at least part of elements according to a preset proportion, so as to obtain the target operating parameter; or

when the target temperature is greater than the first temperature threshold, the processor is specifically configured to raise the operating parameter of the at least part of elements according to a preset proportion, so as to obtain the target operating parameter.

In this embodiment of the present invention, when the target temperature is greater than the first temperature threshold, the processor may raise the operating parameter of the heat generating elements, and when the target temperature is less than the first temperature threshold, the processor may lower the operating parameter of the heat generating elements, so that the surface temperature of the electronic device reaches the target temperature expected by the user.

With reference to the first possible implementation manner of the first aspect of the embodiments of the present invention, or the second possible implementation manner of the first aspect of the embodiments of the present invention, in a third possible implementation manner of the first aspect of the embodiments of the present invention,

the temperature control parameter includes multiple temperature values; the multiple temperature values are within a preset range and each temperature value corresponds to an operating parameter; an upper limit of the preset range is greater than the first temperature threshold, and a lower limit of the preset range is less than the first temperature threshold; and the user interface is specifically configured to receive the adjustment instruction that is generated when the user selects any one of the multiple temperature values as the target temperature.

In this embodiment of the present invention, the temperature control parameter includes multiple temperature values for selection by the user, so that it is convenient for the user to select a temperature control parameter, and time is reduced.

With reference to the first possible implementation manner of the first aspect of the embodiments of the present invention, in a fourth possible implementation manner of the first aspect of the embodiments of the present invention,

the temperature control parameter includes a first parameter and a second parameter, the first parameter is used to indicate that a current surface temperature of the electronic device is acceptable to the user, and the second parameter is used to indicate that the current surface temperature of the electronic device is unacceptable to the user; and the user interface is specifically configured to receive the adjustment instruction that is generated when the user selects the second parameter.

In this embodiment of the present invention, the temperature control parameter includes the first parameter and the second parameter, the first parameter is used to indicate that the current surface temperature of the electronic device is acceptable to the user, and the second parameter is used to indicate that the current surface temperature of the electronic device is unacceptable to the user. In this way, user experience is reflected more intuitively, a value of a temperature does not need to be displayed, and the user only needs to choose whether the current surface temperature of the electronic device is acceptable or unacceptable, thereby providing a feasible solution for the present invention.

With reference to the fourth possible implementation manner of the first aspect of the embodiments of the present invention, in a fifth possible implementation manner of the first aspect of the embodiments of the present invention,

the user interface is specifically configured to receive the adjustment instruction that is generated when the user selects the first parameter; and

the processor is further configured to: when the current surface temperature of the electronic device is greater than the first temperature threshold, set the first temperature threshold as the current surface temperature according to the adjustment instruction.

In this embodiment of the present invention, if the current surface temperature of the electronic device is greater than the first temperature threshold, the processor may directly set the first temperature threshold as the current surface temperature. In this way, the performance of the electronic device is not affected temporarily, and is relatively good.

With reference to the first aspect of the embodiments of the present invention, in a sixth possible implementation manner of the first aspect of the embodiments of the present invention,

the temperature control parameter includes a specified temperature entered by the user, and the user interface is specifically configured to receive the adjustment instruction that is generated when the user selects the specified temperature as the target temperature.

In this embodiment of the present invention, in a feasible solution, the user may directly enter, on the display, the target temperature acceptable to the user. This solution reflects user requirements more clearly and directly.

With reference to the first aspect of the embodiments of the present invention, or the second possible implementation manner of the first aspect of the embodiments of the present invention, in a seventh possible implementation manner of the first aspect of the embodiments of the present invention,

the temperature control parameter includes the first parameter and the second parameter, the first parameter is used to indicate that a current surface temperature of the electronic device is acceptable to the user, and the second parameter is used to indicate that the current surface temperature of the electronic device is unacceptable to the user;

the user interface is specifically configured to receive the adjustment instruction that is generated when the user selects the first parameter; and

the processor is further configured to switch the first temperature threshold to a second temperature threshold according to the adjustment instruction, where the second temperature threshold is greater than the first temperature threshold.

In this embodiment of the present invention, when the first temperature threshold is not canceled, if the current surface temperature of the electronic device is acceptable to the user, the processor may switch the first temperature threshold to the second temperature threshold. Because the second temperature threshold is greater than the first temperature threshold, performance experience of electronic device is improved.

With reference to any one of the first aspect of the embodiments of the present invention, or the second possible implementation manner of the first aspect of the embodiments of the present invention to the seventh possible implementation manner of the first aspect of the embodiments of the present invention, in an eighth possible implementation manner of the first aspect of the embodiments of the present invention,

the processor is further configured to: record, in a memory or a register, an adjusted target operating parameter of the at least part of elements, and when the electronic device is restarted, run the at least part of elements by means of the target operating parameter.

In this embodiment of the present invention, the adjusted target operating parameter of the at least part of elements are recorded, so that when the electronic device is restarted, the operating parameter of the heat generating elements does not need to be rewritten and the adjusted target operating parameter of the at least part of heat generating elements can be directly used, thereby reducing workload.

With reference to any one of the first aspect of the embodiments of the present invention, or the second possible implementation manner of the first aspect of the embodiments of the present invention to the eighth possible implementation manner of the first aspect of the embodiments of the present invention, in a ninth possible implementation manner of the first aspect of the embodiments of the present invention,

the processor is further configured to: when adjusting the operating parameter of the at least part of elements, record, in the memory or the register, an operating parameter that corresponds to at least one of a geographical position or a season of the electronic device; and when the electronic device is in at least one of the geographical position or the season again, run the at least part of elements by means of the operating parameter corresponding to at least one of the geographical position or the season.

In this embodiment of the present invention, the operating parameter that corresponds to at least one of the geographical position or a season of the electronic device, and when the electronic device is in at least one of the geographical position or the season again, the at least part of elements are run by means of the operating parameter corresponding to at least one of the geographical position or the season, so that the operating parameter of the heat generating elements does not need to be adjusted again, thereby reducing time.

With reference to any one of the first aspect of the embodiments of the present invention, or the second possible implementation manner of the first aspect of the embodiments of the present invention to the ninth possible implementation manner of the first aspect of the embodiments of the present invention, in a tenth possible implementation manner of the first aspect of the embodiments of the present invention,

the target operating parameter includes but is not limited to at least one of an operating frequency, an operating voltage, or an operating current of the at least part of elements.

A second aspect of the embodiments of the present invention further provides an electronic device, where the electronic device includes:

a display module, configured to display a temperature control parameter during operation of the electronic device;

a receiving module, configured to receive the adjustment instruction that is generated when a user selects the temperature control parameter;

an obtaining module, configured to obtain a target operating parameter corresponding to the adjustment instruction; and an adjustment module, configured to adjust at least part of elements in the heat generating component from an operating parameter that corresponds to a preset first temperature threshold to the target operating parameter, where the target operating parameter corresponds to a target temperature.

With reference to the second aspect of the embodiments of the present invention, in a first possible implementation manner of the second aspect of the embodiments of the present invention,

the display module is further configured to display a first temperature threshold cancel identifier;

the receiving module is further configured to receive a cancel instruction that is generated when the user selects the first temperature threshold cancel identifier; and

the adjustment module is further configured to cancel, according to the cancel instruction received by the user interface, control by using the first temperature threshold, so that the operating parameter of the at least part of elements is not limited by the first temperature threshold.

With reference to the second aspect of the embodiments of the present invention, or the first possible implementation manner of the second aspect of the embodiments of the present invention, in a second possible implementation manner of the second aspect of the embodiments of the present invention,

the adjustment module is specifically configured to: when the target temperature is less than the first temperature threshold, lower the operating parameter of the at least part of elements according to a preset proportion, so as to obtain the target operating parameter; or when the target temperature is greater than the first temperature threshold, raise the operating parameter of the at least part of elements according to a preset proportion, so as to obtain the target operating parameter.

With reference to the first possible implementation manner of the second aspect of the embodiments of the present invention, or the second possible implementation manner of the second aspect of the embodiments of the present invention, in a third possible implementation manner of the second aspect of the embodiments of the present invention,

the temperature control parameter includes multiple temperature values; the multiple temperature values are within a preset range and each temperature value corresponds to an operating parameter; and an upper limit of the preset range is greater than the first temperature threshold, and a lower limit of the preset range is less than the first temperature threshold; and

the receiving module is specifically configured to receive the adjustment instruction that is generated when the user selects any one of the multiple temperature values as the target temperature.

With reference to the first possible implementation manner of the second aspect of the embodiments of the present invention, in a fourth possible implementation manner of the second aspect of the embodiments of the present invention,

the temperature control parameter includes a first parameter and a second parameter, the first parameter is used to indicate that a current surface temperature of the electronic device is acceptable to the user, and the second parameter is used to indicate that the current surface temperature of the electronic device is unacceptable to the user;

the receiving module is specifically configured to receive the adjustment instruction that is generated when the user selects the second parameter; and

the adjustment module is specifically configured to lower the operating parameter of the at least part of elements according to the adjustment instruction and a preset proportion.

With reference to the fourth possible implementation manner of the second aspect of the embodiments of the present invention, in a fifth possible implementation manner of the second aspect of the embodiments of the present invention,

the receiving module is specifically configured to receive the adjustment instruction that is generated when the user selects the first parameter; and

the adjustment module is further configured to: when the current surface temperature of the electronic device is greater than the first temperature threshold, set the first temperature threshold as the current surface temperature according to the adjustment instruction.

With reference to the second aspect of the embodiments of the present invention, the fourth possible implementation manner of the second aspect of the embodiments of the present invention, or the fourth possible implementation manner of the second aspect of the embodiments of the present invention, in a sixth possible implementation manner of the second aspect of the embodiments of the present invention,

the temperature control parameter includes a specified temperature entered by the user; and

the receiving module is specifically configured to receive the adjustment instruction that is generated when the user selects the specified temperature as the target temperature.

With reference to the second aspect of the embodiments of the present invention, or the second possible implementation manner of the second aspect of the embodiments of the present invention, in a seventh possible implementation manner of the second aspect of the embodiments of the present invention,

the temperature control parameter includes the first parameter and the second parameter, the first parameter is used to indicate that a current surface temperature of the electronic device is acceptable to the user, and the second parameter is used to indicate that the current surface temperature of the electronic device is unacceptable to the user;

the receiving module is specifically configured to receive the adjustment instruction that is generated when the user selects the first parameter; and

the adjustment module is further configured to switch the first temperature threshold to a second temperature threshold according to the adjustment instruction, where the second temperature threshold is greater than the first temperature threshold.

With reference to any one of the second aspect of the embodiments of the present invention, or the second possible implementation manner of the second aspect of the embodiments of the present invention to the seventh possible implementation manner of the second aspect of the embodiments of the present invention, in an eighth possible implementation manner of the second aspect of the embodiments of the present invention,

the electronic device further includes a recording module; where

the recording module is specifically configured to: record, in a memory or a register, an adjusted target operating parameter of the at least part of elements, and when the electronic device is restarted, run the at least part of elements by means of the target operating parameter.

With reference to any one of the second aspect of the embodiments of the present invention, or the second possible implementation manner of the second aspect of the embodiments of the present invention to the eighth possible implementation manner of the second aspect of the embodiments of the present invention, in a ninth possible implementation manner of the second aspect of the embodiments of the present invention,

the recording module is further configured to: when the operating parameter of the at least part of elements is adjusted, record, in the memory or the register, an operating parameter that corresponds to at least one of a geographical position or a season of the electronic device; and when the electronic device is in at least one of the geographical position or the season again, run the at least part of elements by means of the operating parameter corresponding to at least one of the geographical position or the season.

With reference to any one of the second aspect of the embodiments of the present invention, or the second possible implementation manner of the second aspect of the embodiments of the present invention to the ninth possible implementation manner of the second aspect of the embodiments of the present invention, in a tenth possible implementation manner of the second aspect of the embodiments of the present invention,

the target operating parameter includes but is not limited to at least one of an operating frequency, an operating voltage, or an operating current of the at least part of elements.

A third aspect of the embodiments of the present invention further provides a temperature adjustment method, where the method specifically corresponds to functions executed by the electronic device in the first aspect or the second aspect, and details are not described herein again.

A fourth aspect of the embodiments of the present invention further provides a storage medium. The technical solutions of the present invention essentially, or the part contributing to the prior art, or all or some of the technical solutions may be implemented in a form of a software product. The computer software product is stored in a storage medium that is for storing a computer software instruction used by the foregoing electronic device, including a program designed for performing the first aspect, the second aspect, and the third aspect. The computer software product is stored in a storage medium and includes several instructions for instructing a computer device (which may be a personal computer, a server, a network device, or the like) to perform all or some of the steps of the methods described in the embodiments of the present invention. The foregoing storage medium includes: any medium that can store program code, for example, a USB flash drive, a removable hard disk, a read-only memory (ROM), a random access memory (RAM), a magnetic disk, or an optical disc.

It can be seen from the foregoing technical solutions that, the embodiments of the present invention have the following advantages:

In the technical solutions in the embodiments of the present invention, an electronic device includes: a display, a user interface, a processor, and a heat generating component. The display may display a temperature control parameter during operation of the electronic device; the user interface receives an adjustment instruction that is generated when a user selects the temperature control parameter; the processor obtains a target temperature corresponding to the adjustment instruction, and adjusts, according to the adjustment instruction, an operating parameter of the heat generating component, so as to minimize an absolute value of a difference between a surface temperature of the electronic device and the target temperature, so that the surface temperature of the electronic device reaches the target temperature acceptable to the user, thereby improving user experience.

### BRIEF DESCRIPTION OF DRAWINGS

To describe the technical solutions in the embodiments of the present invention more clearly, the following briefly introduces the accompanying drawings required for describing the embodiments and the prior art. Apparently, the accompanying drawings in the following description show merely some embodiments of the present invention, and a person of ordinary skill in the art may still derive other drawings from these accompanying drawings without creative efforts.

FIG. 1 is a schematic structural diagram of an electronic device according to an embodiment of the present invention;

FIG. 2 is a schematic diagram showing that a display cancels control by using a temperature threshold according to an embodiment of the present invention;

FIG. 3 is another schematic diagram showing that a display cancels control by using a temperature threshold according to an embodiment of the present invention;

FIG. 4 is a schematic diagram of an embodiment of an electronic device according to an embodiment of the present invention;

FIG. 5 is a schematic diagram of another embodiment of an electronic device according to an embodiment of the present invention;

FIG. 6 is a schematic diagram of another embodiment of an electronic device according to an embodiment of the present invention; and

FIG. 7 is a schematic diagram of another embodiment of an electronic device according to an embodiment of the present invention.

### DESCRIPTION OF EMBODIMENTS

Embodiments of the present invention provide an electronic device, so as to adjust an operating parameter of a heat generating component in the electronic device, so that a surface temperature of the electronic device maintains a target temperature that is acceptable to a user.

To make a person skilled in the art understand the technical solutions in the present invention better, the following clearly describes the technical solutions in the embodiments of the present invention with reference to the accompanying drawings in the embodiments of the present invention. Apparently, the described embodiments are merely some rather than all of the embodiments of the present invention. All other embodiments obtained by a person of ordinary skill in the art based on the embodiments of the present invention without creative efforts shall fall within the protection scope of the present invention.

The technical solutions in the embodiments of the present invention are mainly applied to an electronic device, and the electronic device commonly is a smartphone, a smart watch, a personal digital assistant (PDA), or the like. The electronic device includes a display, a user interface, a heat generating component, or the like. The heat generating component includes a chip or a processor in the electronic device.

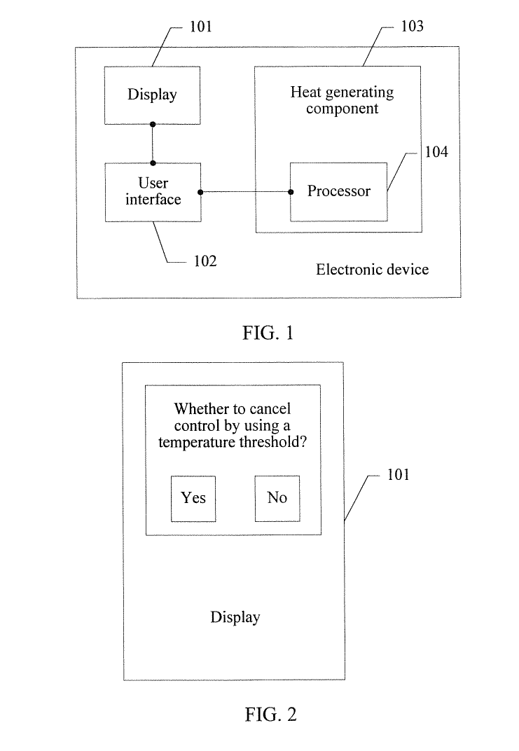

Referring to FIG. 1, FIG. 1 is a schematic structural diagram of an electronic device provided in an embodiment of the present invention.

101. Display

The display is also generally referred to as a display screen, that is, a commonly used operating interface on the electronic device. The display belongs to an I/O device, that is, an input/output device, of an electronic product. The display is a display tool that displays an electronic document on a screen by means of a particular transmission device and then presents the document to a user. Generally, the display may be classified, according to different manufacturing materials, into: a TFT (Thin Film Transistor) liquid crystal display, a UFB (Ultra Fine Bright) liquid crystal display, a super twisted nematic (STN) screen, an active matrix/organic light emitting diode (AMOLED) display screen, or another type of display screen, and display screens are not listed one by one herein.

In the technical solutions in this embodiment of the present invention, the display is configured to display a temperature control parameter during operation of the electronic device.

102. User Interface

The user interface (UI) is a medium for interaction and information exchanging between the electronic device and the user. The user interface implements conversion of information from a device-internal form into a form acceptable to the user, and generally may refer to a software interface or a hardware interface. The software interface generally has three types, namely, a command interface, a program interface, and a graphic interface. The hardware interface may be a sensor or a corresponding sensor signal processing circuit.

For example, the user interface may be related software designed for interaction between the user and the hardware, so that the user can operate the hardware conveniently and effectively to achieve bidirectional interaction and complete a job by means of the hardware. The user interface has a wide definition, including a human-computer interaction interface or a graphical user interface. The user interface exists in all fields that are related to information communication between a user and an electronic device.

Optionally, the user interface may be further configured to receive an adjustment instruction that is generated when the user selects the temperature control parameter.

Alternatively, the user interface is a sensor or a related circuit. In multiple electronic devices, the sensor may be stacked with the display 101 to form a touchscreen display. For example, the user interface 102 may be disposed above or below the display 101, so as to sense user contact. Alternatively, the user interface may be another input device, for example, a keyboard or a touchpad, and does not need to be stacked with the display 101, but is an independent device. This is not limited in this embodiment of the present invention.

103. Heat Generating Component

Generally, the electronic device includes multiple components. These components generate some heat during operation, and are collectively referred to as the heat generating component herein. For example, the heat generating component may be at least one of a central processing unit (CPU), a graphics processing unit (GPU), a voice module, a radio frequency (RF) component, or a DSP (digital signal processor).

A description is made by using an example in which the electronic device is a mobile phone. For example, a temperature sensor is disposed on a preset position on a chip or on a circuit board (that is, a heat generating component) in the mobile phone, so that when it is detected that a temperature of the heat generating component reaches a particular temperature, the chip may adjust, based on selection or triggering by the user, an operating frequency, an operating voltage, or an operating current of at least part of elements in the chip, so as to control heat generation. For example, if a temperature sensor near the CPU detects that the temperature reaches a particular value, an operating frequency, and/or an operating voltage, and/or an operating current of the CPU is adjusted to a value corresponding to a preset temperature. If a similar temperature sensor is disposed near the GPU, the voice module, the RF component, or a battery, when the temperature reaches a particular value, the operating frequency, and/or the operating voltage, and/or the operating current of the component is adjusted to the value corresponding to the preset temperature. If the temperature is excessively high (exceeds an alarm value), some heat generating elements or some functions of the chip may be disabled, or some operating elements of the circuit board may be disabled. If the temperature is excessively high (unacceptable), the entire mobile phone may be switched off.

104. Processor

The processor may be a general CPU, a microprocessor, an application-specific integrated circuit (ASIC), or one or more of integrated circuits configured to control implementation of the procedures in the solutions in this embodiment of the present invention, or may be an integrated circuit chip having a capability of signal processing, or may be a general purpose processor, a DSP, an ASIC, a field programmable gate array (FPGA) or another programmable logic device, a discrete gate, a transistor logic device, or a discrete hardware component. The processor may implement or perform the methods, steps, and logical block diagrams in this embodiment of the present invention. The general purpose processor may be a microprocessor, or may be any commonly used processor.

In the technical solutions in this embodiment of the present invention, the processor is configured to: obtain a target operating parameter corresponding to the adjustment instruction, and adjust at least part of elements in the heat generating component from an operating parameter that corresponds to a preset first temperature threshold to the target operating parameter, where the target operating parameter corresponds to a target temperature.

Based on the foregoing descriptions, in some implementation manners of the present invention, the processing may be classified into the following two cases: cancel control by using the first temperature threshold of the electronic device; not cancel control by using the first temperature threshold of the electronic device.

Case 1: Cancel control by using the first temperature threshold of the electronic device.

1. The display 101 is further configured to display a first temperature threshold cancel identifier.

When the user uses the electronic device, the display displays the first temperature threshold cancel identifier. It should be understood that the display herein is a common screen, that is, an operation interface. For details, refer to the foregoing descriptions about the display. The first temperature threshold is a factory-set high temperature alarm value of the electronic device. When a surface temperature of the electronic device reaches the high temperature alarm value, the electronic device stops running some programs, or lowers an operating parameter of some heat generating elements, so as to ensure that the surface temperature of the electronic device does not exceed the first temperature threshold.

When the electronic device stops running some applications or lowers the operating parameter of some heat generating elements, corresponding performance of the electronic device also deteriorates. Therefore, the following phenomenon may occur: The operation interface fails to respond timely, image display is discontinuous, or the like. If the control by using the first temperature threshold is canceled, the surface temperature of the electronic device increases with the operation of the electronic device. Although the surface temperature is relatively high, the performance is not affected. It should be noted that the surface temperature herein does not increase without limitation. When an electronic product is designed, there is a final critical temperature that is a different concept from the first temperature threshold. The first temperature threshold is generally a greatest temperature value, acceptable and conforming to most user experience, of a surface temperature of the electronic product. If the temperature exceeds the first temperature threshold, hands of the user feel hot, uncomfortable, or the like. The final critical temperature is the highest temperature that the electronic product can bear. When the temperature exceeds the first temperature threshold, the electronic device or the chip in the electronic device or some function units in the chip may be disabled or implementation parameters are lowered.

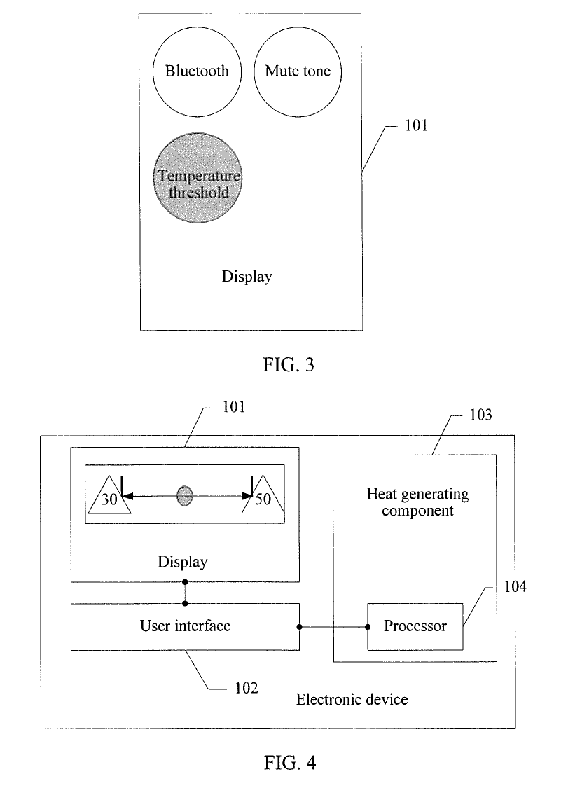

The first temperature threshold cancel identifier displayed herein may be a window that pops up on the display screen and that displays whether to cancel the control by using the first temperature threshold. If “Yes” is clicked, it indicates that the control is canceled; if “No” is clicked, it indicates that the control is not canceled. For understanding, refer to FIG. 2. The first temperature threshold cancel identifier may further be a shortcut icon such as a Bluetooth icon, a mute tone icon, or a vibration icon. If the shortcut icon of the first temperature threshold is in bright color, it indicates that the control is canceled; if the shortcut icon of the first temperature threshold is in dark color, it indicates that the control is not canceled. For understanding, refer to FIG. 3. It should be noted that there may further be another implementing manner of displaying the first temperature threshold cancel identifier, and this is specifically not limited herein.

2. The user interface 102 is further configured to receive a cancel instruction that is generated when the user selects the first temperature threshold cancel identifier.

After the user selects the first temperature threshold cancel identifier on the display, the cancel instruction is generated, and the cancel instruction is received by the user interface. The user interface (UI) is a medium for interaction and information exchanging between the electronic device and the user. The user interface implements conversion of information from an internal form into a form acceptable to the user, and generally may refer to a software interface.

3. The processor 104 is further configured to cancel, according to the cancel instruction received by the user interface, control by using the first temperature threshold, so that the operating parameter of the at least part of elements is not limited by the first temperature threshold.

The processor cancels, according to the cancel instruction received by the user interface, control by using the first temperature threshold, so that the operating parameter of the at least part of elements is not limited by the first temperature threshold. The first temperature threshold is a factory-set critical temperature value of the electronic device. In this case, a phenomenon that the surface temperature of the electronic device is greater than the first temperature threshold occurs, that is, when the electronic device reaches the first temperature threshold, the user feels that the temperature is still acceptable, and expects that the performance of the electronic device maintains steady for a while. The surface temperature of the electronic device may further increase at a particular amplitude.

On the basis of canceling the control by using the first temperature threshold, because the temperature control parameter may be displayed in different manners, the following further describes the electronic device in the embodiments of the present invention.

(1) The temperature control parameter includes multiple temperature values.

Referring to FIG. 4, FIG. 4 is a schematic diagram of an embodiment of an electronic device according to an embodiment of the present invention.

a. The display 101 is specifically configured to display the multiple temperature values. The multiple temperature values are within a preset range and each temperature value corresponds to an operating parameter. An upper limit of the preset range is greater than the first temperature threshold, and a lower limit of the preset range is less than the first temperature threshold.

In an actual application of the electronic device, although there is a factory-set temperature control solution, the factory-set temperature values may not meet requirements of all users. During an operation process of the electronic device, the display displays the multiple temperature values. The multiple temperature values are within the preset range and each temperature value corresponds to an operating parameter. The upper limit of the preset range is greater than the first temperature threshold, and the lower limit of the preset range is less than the first temperature threshold. It should be noted that the preset range is an empirical value. Assuming that the factory-set first temperature threshold of the electronic device is 45 degrees, the preset range may be 30 degrees to 50 degrees, and 50 degrees may be considered as the foregoing final critical temperature.

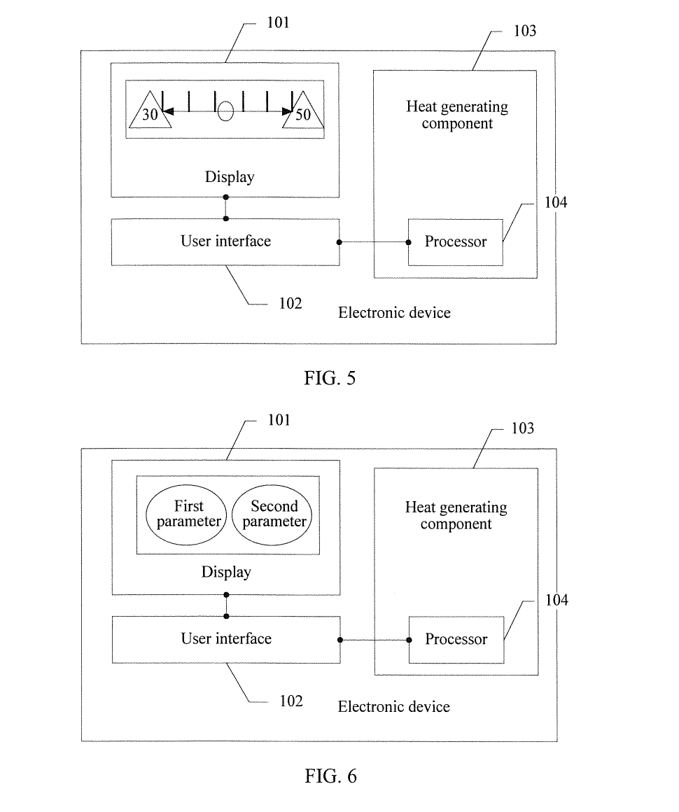

The preset range may be implemented in a manner similar to that of adjusting screen brightness, for example, the user selects a satisfactory target temperature by means of left-right sliding, or may be implemented in a manner that the multiple temperature values within the preset range are generated according to a preset step. For understanding, refer to FIG. 5. For example, a table is generated between 30 degrees and 50 degrees according to a preset step, and values such as 30 degrees, 35 degrees, 40 degrees, 45 degrees, and 50 degrees are provided for the user to select. The preset step is not limited herein. Generally, a lower limit value is not set excessively low, because the performance of the electronic device needs to be ensured.

b. The user interface 102 is specifically configured to receive the adjustment instruction that is generated when the user selects any one of the multiple temperature values.

The user selects, from the multiple temperature values, an acceptably highest temperature as a target temperature. Whichever temperature value is selected by the user, the adjustment instruction corresponding to the temperature value is generated. The user interface receives the adjustment instruction that is generated when the user selects any one of the multiple temperature values.

c. The processor 104 is configured to: obtain a target operating parameter corresponding to the adjustment instruction, and adjust at least part of elements in the heat generating component from an operating parameter that corresponds to the preset first temperature threshold to the target operating parameter, where the target operating parameter corresponds to a target temperature.

The processor obtains the target operating parameter corresponding to the adjustment instruction, and adjusts at least part of elements in the heat generating component from the operating parameter that corresponds to the preset first temperature threshold to the target operating parameter. The target operating parameter corresponds to the target temperature. The target operating parameter includes but is not limited to at least one of an operating frequency, an operating voltage, or an operating current of the at least part of elements. A specific implementation may be classified into the following two cases: When the target temperature is less than the first temperature threshold, the processor lowers, according to a preset proportion, the operating parameter of the at least part of heat generating elements, so as to obtain the target operating parameter; when the target temperature is greater than the first temperature threshold, the processor raises, according to a preset proportion, the operating parameter of the at least part of heat generating elements, so as to obtain the target operating parameter.

For example, when the target temperature selected by the user is 40 degrees, because 40 degrees is less than the first temperature threshold of 45 degrees, the processor lowers, according to the preset proportion, the operating parameter of the heat generating elements, that is, the parameters, such as the operating frequency, the operating voltage, and the operating current, of the at least part of elements, such as the CPU, the GPU, the voice module, and the RF device, of the electronic device, so that the operating parameter reaches the target operating parameter, and an absolute value of a difference between the surface temperature and the target temperature of the electronic device is the smallest. Alternatively, when the target temperature selected by the user is 50 degrees, because 50 degrees is greater than the first temperature threshold of 45 degrees, the processor raises, according to the preset proportion, the operating parameter of the at least part of elements, that is, the parameters, such as the operating frequency, the operating voltage, and the operating current, of the heat generating elements, such as the CPU, the GPU, the voice module, and the RF device, of the electronic device, so that the operating parameter reaches the target operating parameter, and an absolute value of a difference between the surface temperature and the target temperature of the electronic device is the smallest.

When the first temperature threshold is 45 degrees, the corresponding operating parameter of the heat generating elements in the electronic device is shown in FIG. 1. When the target temperature is greater than the first temperature threshold, the processor raises the operating parameter of the at least part of elements. If the target temperature is 40 degrees, the adjusted operating parameter of the heat generating elements are shown in FIG. 2. When the target temperature is less than the first temperature threshold, the processor lowers the operating parameter of the at least part of elements, and if the target temperature is 50 degrees, the adjusted operating parameter of the heat generating elements are shown in FIG. 3.

TABLE 1

| Heat generating | Operating current | Operating | |
|---|---|---|---|
| element | (A) | frequency | |
| CPU | | 2 | GHz |
| GPU | | 650 | MHz |
| Battery | 2 | | |

TABLE 2

| Heat generating | Operating current | Operating | |
|---|---|---|---|
| element | (A) | frequency (HZ) | |
| CPU | | 1.5 | GHz |
| GPU | | 450 | MHz |
| Battery | 1 | | |

TABLE 3

| Heat generating | Operating current | Operating | |
|---|---|---|---|
| element | (A) | frequency (HZ) | |
| CPU | | 2.2 | GHz |
| GPU | | 700 | MHz |
| Battery | 2.5 | | |

It should be understood that the values in the tables are merely examples of descriptions, and may be different greatly from those in practice. In a specific implementation manner, the values may be determined according to an actual application. The heat generating elements include but are not limited to a CPU, a GPU, and a battery. Likewise, the operating parameter includes but is not limited to an operating voltage, an operating current, and an operating frequency.

It should be noted that, when people use an electronic device and feel that a surface temperature of the electronic device is hot, a phenomenon that some applications are slow in response or page loading is slow usually occurs. Because when the surface temperature of the electronic device reaches the first temperature threshold, some applications are disabled, or the operating parameter of some heat generating elements is adjusted to a preset parameter. As a result, some applications are slow in response, that is, performance is poor. When the target temperature selected by the user is greater than the first temperature threshold, the operating parameter of the heat generating elements is raised, so that the performance is relatively good. Certainly, there is a disadvantage, that is, the user needs to accept the relatively high surface temperature of the electronic device. In an actual application, the user may make a selection according to actual requirements of the user.

In this embodiment of the present invention, the display displays multiple temperature control parameters that are provided for a user to select. The user interface receives the adjustment instruction that is generated when the user selects a temperature control parameter. The processor obtains a target operating parameter corresponding to the adjustment instruction, and adjusts at least part of elements in the heat generating component from an operating parameter that corresponds to a first temperature threshold to the target operating parameter. The target operating parameter corresponds to the target temperature, so that the surface temperature of the electronic device maintains the target temperature acceptable to the user. In this implementation manner, the display displays multiple temperature control parameters, so that the user may see the parameters clearly and may select decisively the target temperature, acceptable to the user, of the electronic device.

(2) The temperature control parameter includes a first parameter and a second parameter. The first parameter is used to indicate that a current surface temperature of the electronic device is acceptable to the user, and the second parameter is used to indicate that the current surface temperature of the electronic device is unacceptable to the user.

Referring to FIG. 6, FIG. 6 is a schematic diagram of another embodiment of an electronic device according to an embodiment of the present invention.

a. The display 101 is specifically configured to display the first parameter and the second parameter.

In another possible implementation manner, the temperature control parameter includes the first parameter and the second parameter. The first parameter is used to indicate that the current surface temperature of the electronic device is acceptable to the user, and the second parameter is used to indicate that the current surface temperature of the electronic device is unacceptable to the user. The display is specifically configured to display the first parameter and the second parameter. The first parameter and the second parameter may be specifically implemented in the following manner: A window pops up, indicating “Yes” or “No”, “1” or “0”. “Yes” and “1” indicate that the current surface temperature of the electronic device is acceptable to the user, while “No” and “0” indicate that the current surface temperature of the electronic device is not acceptable to the user. Implementation manners of the first parameter and the second parameter are not limited herein.

b. The user interface 102 is specifically configured to receive the adjustment instruction that is generated when the user selects the second parameter. If the user selects the second parameter, the user interface receives the adjustment instruction that is generated when the user selects the second parameter.

c. The processor 104 is specifically configured to lower the operating parameter of the at least part of elements according to the adjustment instruction and a preset proportion.

The processor lowers the operating parameter of the at least part of elements according to the adjustment instruction and the preset proportion. When the user selects the second parameter, it indicates that the current surface temperature of the electronic device is unacceptable to the user. In this case, no matter whether the current surface temperature of the electronic device is greater than the first temperature threshold, the processor lowers the operating parameter of the heat generating elements according to the preset proportion, and lowers the surface temperature of the electronic device.

For example, if the current surface temperature of the electronic device obtained by the processor is 40 degrees when the user selects the second parameter, the user cannot accept the current surface temperature of the electronic device, and the processor may lower, according to the preset proportion, the operating parameter of at least part of elements, such as an operating frequency, a voltage, or a current, so that the surface temperature of the electronic device is lowered to reach the temperature acceptable to the user.

d. The user interface 102 is specifically configured to receive the adjustment instruction that is generated when the user selects the first parameter. If the user selects the first parameter, the user interface receives the adjustment instruction that is generated when the user selects the first parameter.

e. The processor 104 is further configured to: when the current surface temperature of the electronic device is greater than the first temperature threshold, set the first temperature threshold as the current surface temperature according to the adjustment instruction.

The user interface receives the adjustment instruction that is generated when the user selects the first parameter. The current surface temperature, corresponding to the first parameter, of the electronic device is acceptable to the user. If the current surface temperature of the electronic device is greater than the first temperature threshold, the first temperature threshold is set as the current surface temperature according to the adjustment instruction. In this way, the first temperature threshold is greater, and the performance of the electronic device is correspondingly better. For example, when the user selects the first parameter, if the surface temperature of the electronic device is 48 degrees, acceptable to the user, the processor may set the original first temperature threshold of 45 degrees to 48 degrees.

It should be noted that after the first temperature threshold is set as the current surface temperature, because the first temperature threshold is larger, the operating parameter of some heat generating elements may further be raised.

In this embodiment of the present invention, the user feels the surface temperature of the electronic device, if the user thinks that the surface temperature is acceptable, the user selects the first parameter, and if the user thinks that the surface temperature is unacceptable, the user selects the second parameter. In this way, the operating parameter of heat generating elements is adjusted according to actual experience of the user, so that user experience is better.

(3) The temperature control parameter includes a specified temperature entered by the user.

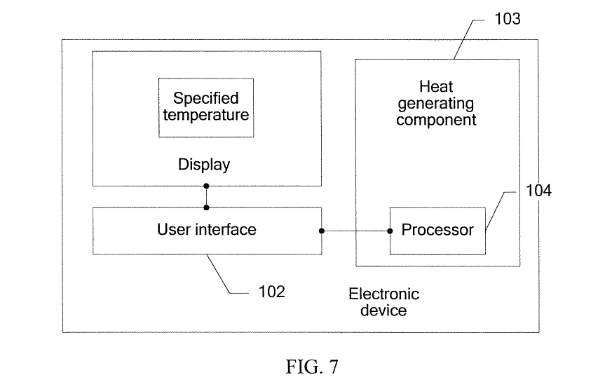

Referring to FIG. 7, FIG. 7 is a schematic diagram of another embodiment of an electronic device according to an embodiment of the present invention.

a. The display 101 is specifically configured to display the specified temperature entered by the user.

In this implementation manner, the display is specifically configured to display the specified temperature entered by the user, that is, the user enters an expected surface temperature of the electronic device according to actual requirements of the user.

b. The user interface 102 is specifically configured to receive the adjustment instruction that is generated when the user selects the specified temperature as the target temperature, that is, the adjustment instruction that is generated after the user enters the specified temperature and the user interface receives the specified temperature entered by the user.

c. The processor 104 is configured to: obtain a target operating parameter corresponding to the adjustment instruction, and adjust at least part of elements in the heat generating component from an operating parameter that corresponds to the preset first temperature threshold to the target operating parameter, where the target operating parameter corresponds to a target temperature.

The processor obtains the specified temperature entered by the user, uses the specified temperature as the target temperature, and adjusts at least part of elements in the heat generating component from the operating parameter that corresponds to the preset first temperature threshold to the target operating parameter. The target operating parameter corresponds to the target temperature. The target operating parameter includes but is not limited to at least one of an operating frequency, an operating voltage, or an operating current of the at least part of elements. A specific implementation may be classified into the following two cases: When the target temperature is less than the first temperature threshold, the processor lowers, according to a preset proportion, the operating parameter of the at least part of heat generating elements, so as to obtain the target operating parameter; when the target temperature is greater than the first temperature threshold, the processor raises, according to a preset proportion, the operating parameter of the at least part of heat generating elements, so as to obtain the target operating parameter.

For example, when the user enters 42.5 degrees, less than the first temperature threshold of 45 degrees, the processor may lower, according to the preset proportion, the operating parameter of the at least part of elements, such as the operating frequency, the voltage, or the current, so as to obtain the target operating parameter. When the user enters 48.5 degrees, greater than the first temperature threshold of 45 degrees, the processor may raise, according to the preset proportion, the operating parameter of the at least part of elements, such as the operating frequency, the voltage, or the current, so as to obtain the target operating parameter, so that the surface temperature of the electronic device reaches a satisfactory temperature of the user. For understanding, refer to the adjusted operating parameter of the heat generating elements in Table 1, Table 2, and Table 3.

In this embodiment of the present invention, the user may enter a surface temperature that is acceptable to the user, thereby increasing optionality for the user. The processor adjusts the operating parameter of the heat generating elements according to the adjustment instruction that is generated when the user makes a selection, thereby implementing flexibility of temperature adjustment and improving user experience.

Case 2. Not cancel control by using the first temperature threshold of the electronic device. The temperature control parameter includes a first parameter and a second parameter. The first parameter is used to indicate that a current surface temperature of the electronic device is acceptable to a user, and the second parameter is used to indicate that the current surface temperature of the electronic device is unacceptable to the user.

a. The display 101 is specifically configured to display the first parameter and the second parameter.

b. The user interface 102 is specifically configured to receive the adjustment instruction that is generated when the user selects the first parameter.

c. The processor 104 is specifically configured to switch the first temperature threshold to a second temperature threshold according to the adjustment instruction, where the second temperature threshold is greater than the first temperature threshold.

A precondition of this embodiment is: Not cancel control by using the first temperature threshold of the electronic device. Therefore, no matter whether the user selects the first parameter or the second parameter, the current surface temperature of the electronic device does not exceed the first temperature threshold. In this case, when the user selects the first parameter, that is, when the user can accept the current surface temperature of the electronic device, the processor may switch, according to the adjustment instruction, the first temperature threshold to the second temperature threshold. The second temperature threshold is greater than the first temperature threshold. It should be noted that the second temperature threshold is also an empirical value. The electronic device may be operated normally when the surface temperature is within the second temperature threshold, only the surface temperature is relatively high.

For example, when the user selects the first parameter, the current surface temperature of the electronic device is 44 degrees, acceptable to the user, and the processor may switch the first temperature threshold of 45 degrees to the second temperature threshold of 48 degrees.

In this embodiment of the present invention, the electronic device may be flexibly adjusted according to user requirements. Therefore, another feasible solution is provided.

Optionally, in some embodiments of the present invention, the processor 104 records, in a memory or a register, an adjusted target operating parameter of at least part of elements, and when the electronic device is restarted, runs the at least part of elements by means of the target operating parameter.

After the electronic device adjusts the operating parameter of the heat generating elements according to the user selection, the processor records the adjusted target operating parameter of the at least part of elements, and when the electronic device is restarted, runs the at least part of elements by means of the target operating parameter. It should be noted that, in an optional implementation manner, the user may further make a selection again according to requirements of the user, or may use factory-setting of the electronic device.

Optionally, in some embodiments of the present invention, the processor 104 is further configured to: when adjusting the operating parameter of the at least part of elements, record, in the memory or the register, an operating parameter that corresponds to at least one of a geographical position or a season of the electronic device; and when the electronic device is in at least one of the geographical position or the season again, run the at least part of elements by means of the operating parameter corresponding to at least one of the geographical position or the season.

The foregoing describes the electronic device in the embodiments of the present invention. The present invention further provides an embodiment of a temperature adjustment method. The method is understood and applied with reference to the foregoing electronic device, and details are not described herein again.

An embodiment of the present invention further provides a computer storage medium, configured to store a computer software instruction used by the electronic device described in FIG. 1 to FIG. 6. When the stored programs are executed, the operating parameter of the heat generating elements in the electronic device may be adjusted, so that a surface temperature of the electronic device can be accepted by the user, and user experience is improved. When the program is implemented in the form of a software functional unit and sold or used as an independent product, the program may be stored in a computer-readable storage medium. Based on such an understanding, the technical solutions of the present invention essentially, or the part contributing to the prior art, or all or some of the technical solutions may be implemented in the form of a software product. The computer software product is stored in a storage medium and includes several instructions for instructing a computer device (which may be a personal computer, a server, a network device, or the like) to perform all or some of the steps of the methods described in the embodiments of the present invention. The foregoing storage medium includes: any medium that can store program code, for example, a USB flash drive, a removable hard disk, a read-only memory (ROM), a random access memory (RAM), a magnetic disk, or an optical disc.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

The foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

1. An electronic device, comprising:
a display configured to display a temperature control parameter during operation of the electronic device;
a user interface configured to receive an adjustment instruction generated when a user selects the temperature control parameter; and
a heat generating component comprising a processor configured to:
obtain a target operating parameter corresponding to the adjustment instruction, and
adjust at least part of elements in the heat generating component from an operating parameter that corresponds to a preset first temperature threshold to the target operating parameter, wherein the target operating parameter corresponds to a target temperature.

2. The electronic device according to claim 1, wherein:
the display is further configured to display a first temperature threshold cancel identifier;
the user interface is further configured to receive a cancel instruction generated when the user selects the first temperature threshold cancel identifier; and
the processor is further configured to cancel, according to the cancel instruction received by the user interface, control by using the first temperature threshold, so that the operating parameter of the at least part of elements is not limited by the first temperature threshold.

3. The electronic device according to claim 1, wherein:
when the target temperature is less than the first temperature threshold, the processor is configured to lower the operating parameter of the at least part of elements according to a preset proportion, so as to obtain the target operating parameter; or
when the target temperature is greater than the first temperature threshold, the processor is configured to raise the operating parameter of the at least part of elements according to a preset proportion, so as to obtain the target operating parameter.

4. The electronic device according to claim 2, wherein:
the temperature control parameter comprises multiple temperature values;
the multiple temperature values are within a preset range and each temperature value corresponds to an operating parameter, and wherein an upper limit of the preset range is greater than the first temperature threshold, and a lower limit of the preset range is less than the first temperature threshold; and
the user interface is configured to receive the adjustment instruction generated when the user selects any one of the multiple temperature values as the target temperature.

5. The electronic device according to claim 2, wherein:
the temperature control parameter comprises a first parameter and a second parameter, the first parameter is used to indicate that a current surface temperature of the electronic device is acceptable to the user, and the second parameter is used to indicate that the current surface temperature of the electronic device is unacceptable to the user;
the user interface is configured to receive the adjustment instruction generated when the user selects the second parameter; and
the processor is configured to lower the operating parameter of the at least part of elements according to the adjustment instruction and a preset proportion.

6. The electronic device according to claim 5, wherein:
the user interface is configured to receive the adjustment instruction generated when the user selects the first parameter; and
the processor is further configured to: when the current surface temperature of the electronic device is greater than the first temperature threshold, set the first temperature threshold as the current surface temperature according to the adjustment instruction.

7. The electronic device according to claim 1, wherein:
the temperature control parameter comprises a specified temperature entered by the user; and
the user interface is configured to receive the adjustment instruction generated when the user selects the specified temperature as the target temperature.

8. The electronic device according to claim 1, wherein:
the temperature control parameter comprises the first parameter and the second parameter, the first parameter is used to indicate that a current surface temperature of the electronic device is acceptable to the user, and the second parameter is used to indicate that the current surface temperature of the electronic device is unacceptable to the user;
the user interface is configured to receive the adjustment instruction generated when the user selects the first parameter; and
the processor is further configured to switch the first temperature threshold to a second temperature threshold according to the adjustment instruction, wherein the second temperature threshold is greater than the first temperature threshold.

9. The electronic device according to claim 1, wherein the processor is further configured to:
record, in a memory or a register, an adjusted target operating parameter of the at least part of elements; and
when the electronic device is restarted, run the at least part of elements by means of the target operating parameter.

10. The electronic device according to claim 1, wherein the processor is further configured to:
when adjusting the operating parameter of the at least part of elements, record, in the memory or the register, an operating parameter that corresponds to at least one of a geographical position or a season of the electronic device; and
when the electronic device is in at least one of the geographical position or the season again, run the at least part of elements by means of the operating parameter corresponding to at least one of the geographical position or the season.

11. The electronic device according to claim 1, wherein the target operating parameter comprises at least one of an operating frequency, an operating voltage, or an operating current of the at least part of elements in the heat generating component.
